(19) United States
(12) Patent Application Publication
(10) Pub. No.: US 2018/0035031 A1
(43) Pub. Date: Feb. 1, 2018

(54) CAMERA MODULE AND PORTABLE ELECTRONIC DEVICE INCLUDING THE SAME

(71) Applicant: SAMSUNG ELECTRO-MECHANICS CO., LTD., Suwon-si (KR)

(72) Inventors: Jun Ho KWAK, Suwon-si (KR); Hun Keun CHANG, Suwon-si (KR)

(73) Assignee: SAMSUNG ELECTRO-MECHANICS CO., LTD., Suwon-si (KR)

(21) Appl. No.: 15/645,348

(22) Filed: Jul. 10, 2017

(30) Foreign Application Priority Data
Jul. 27, 2016 (KR) 10-2016-0095642
Sep. 13, 2016 (KR) 10-2016-0118395
Apr. 12, 2017 (KR) 10-2017-0047137

(51) Int. Cl. H04N 5/225

(52) U.S. Cl. CPC H04N 5/2257; H04N 5/2254; H04N 5/2252; H04M 1/0264

(57) ABSTRACT

A camera module includes lenses, and reflecting parts disposed in front of the lenses and configured to reflect light incident thereto from different directions to the lenses. A reflecting part of the reflecting parts is rotatable, and a stopper configured to limit a rotation range of the reflecting part.

### CROSS-REFERENCE TO RELATED APPLICATION(S)

This application claims benefit under 35 USC 119(a) of Korean Patent Application No. 10-2016-0095642 filed on Jul. 27, 2016, Korean Patent Application No. 10-2016-0118395 filed on Sep. 13, 2016, and Korean Patent Application No. 10-2017-0047137 filed on Apr. 12, 2017 in the Korean Intellectual Property Office, the disclosures of which are incorporated herein by reference for all purposes.

### BACKGROUND

### 1. Field

The following description relates to a camera module and a portable electronic device including the same.

### 2. Description of Related Art

A camera module is used in portable electronic devices such as tablet personal computers (PC), laptop computers, or the like, as well as in smartphones.

Such portable electronic devices are mounted with a front camera to photograph a subject that is positioned in front of the portable electronic device and a rear camera to photograph a subject that is positioned behind the portable electronic device.

In a case in which the two cameras are mounted in order to perform the bi-directional photographing described above, there have been limitations in miniaturizing the portable electronic device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module is described configured to photograph subjects that are disposed at opposite sides to each other, and a portable electronic device including the same.

In one general aspect, a camera module is described satisfying a demand for miniaturization, and a portable electronic device including the same.

In accordance with an embodiment, there is provided a camera module, including: lenses; and reflecting parts disposed in front of the lenses and configured to reflect light incident thereto from different directions to the lenses, wherein a reflecting part of the reflecting parts may be rotatable, and a stopper configured to limit a rotation range of the reflecting part.

The reflecting part and the stopper may be closely positioned with respect to each other so that the reflecting part rotates to have a preset inclined angle.

The reflecting parts may be mirrors or prisms.

The reflecting parts may further include a first reflecting part configured to reflect light incident thereto from one side to the lenses; and a second reflecting part configured to reflect light incident thereto from another side to the lenses.

The first reflecting part may be configured to be rotatable, and the second reflecting part may be fixed at an inclined angle.

The first reflecting part may be disposed on a level closer to the lenses compared to the second reflecting part, and one surface of the first reflecting part reflects the light, and another surface of the first reflecting part blocks the light.

The camera module may further include a first filter disposed in front of the first reflecting part; and a second filter disposed in front of the second reflecting part, wherein each of the first filter and the second filter may be an infrared ray pass filter or an infrared ray cut-off filter.

The camera module may further include: an actuator rotating the reflecting part.

In accordance with an embodiment, there is provided a camera module including: lenses; reflecting parts disposed in front of the lenses and configured to reflect light incident thereto from different directions to the lenses; actuators configured to rotate the reflecting parts; and stoppers configured to limit rotation ranges of the reflecting parts.

One surface of each of the reflecting parts reflects the light, and another surface of each of the reflecting parts blocks the light.

The stoppers may be provided on surfaces of the reflecting parts facing each other.

The reflecting parts may further include a first reflecting part configured to reflect light incident thereto from one side to the lenses, a second reflecting part configured to reflect light incident thereto from another side to the lenses, and first and second stoppers may be disposed on surfaces of the first and second reflecting parts facing each other.

The first reflecting part may be closely positioned to the second stopper and the first reflecting part rotates to an inclined angle, and the second reflecting part may be closely positioned to the first stopper and the second reflecting part rotates at an inclined angle.

In accordance with an embodiment, there is provided a portable electronic device, including: the camera module described above; and a case including openings formed in one surface and another surface thereof so that light may be incident thereto and accommodating the camera module therein.

In accordance with a further embodiment, there is provided a portable device, including: a first reflecting part disposed at a position aligned with a first opening on a front side of the portable device and rotatably installed with respect to an optical axis, and configured to reflect light incident thereto through the first opening toward a lens of a camera module; and a second reflecting part disposed at a position aligned with a second opening on a rear side of the portable device and fixedly installed at a preset inclined angle with respect to the optical axis, wherein the second reflecting part reflects light incident through the second opening toward the lens of the camera module.

In response to photographing a subject in front of the portable device, the first reflecting part may be closely adhered to the inner surface of the portable device and rotates to a position at which the first reflecting part has an inclined angle with respect to the optical axis.

In response to photographing a subject in front of the portable device, the first reflecting part may be positioned in a moving path of the light reflected by the second reflecting part to block the light reflected by the second reflecting part.

In response to photographing a subject in a rear of the portable device, the first reflecting part rotates to close the first opening to prevent interfering with a moving direction of the light reflected by the second reflecting part.

The second reflecting part may be closely adhered and fixed to an inner surface of the portable device.

The portable device may further include: a stopper fixed in a position within the portable device to limit a rotation range of the first reflecting part to an inclined angle of 45°.

Other features and aspects will be apparent from the following detailed description, the drawings, and the claims.

### BRIEF DESCRIPTION OF DRAWINGS

FIG. 1A is a front perspective view, illustrating a portable electronic device, according to an embodiment;

FIG. 1B is a rear perspective view illustrating the portable electronic device, according to an embodiment;

FIG. 2 is a schematic cross-sectional view taken along line I-I′ of FIG. 1A;

FIG. 3 is a view illustrating an operational state of a camera module, according to an embodiment, when photographing a subject in front of the portable electronic device;

FIG. 4 is a view illustrating an operational state of the camera module, according to the embodiment when photographing a subject at the rear of the portable electronic device;

FIG. 5 is a view illustrating an operational state of a camera module according to a second embodiment in the present disclosure when photographing the subject in front of the portable electronic device;

FIG. 6 is a view illustrating an operational state of the camera module, according to an embodiment, when photographing the subject at the rear of the portable electronic device;

FIG. 7 is a schematic cross-sectional view illustrating a portable electronic device in which a camera module, according to an embodiment, is mounted;

FIG. 8 is a view illustrating an operational state of a camera module, according to an embodiment, when photographing the subject in front of the portable electronic device;

FIG. 9 is a view illustrating an operational state of the camera module according to the fourth embodiment in the present disclosure when photographing the subject at the rear of the portable electronic device;

FIG. 10 is a view illustrating an operational state of a camera module, according to another embodiment, when photographing the subject in front of the portable electronic device;

FIG. 11 is a view illustrating an operational state of the camera module, according to the other embodiment, when photographing the subject at the rear of the portable electronic device;

FIG. 12 is a view illustrating an operational state of a camera module, according to a an embodiment when photographing the subject in front of the portable electronic device; and

FIG. 13 is a view illustrating an operational state of the camera module, according to an embodiment when photographing the subject at the rear of the portable electronic device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

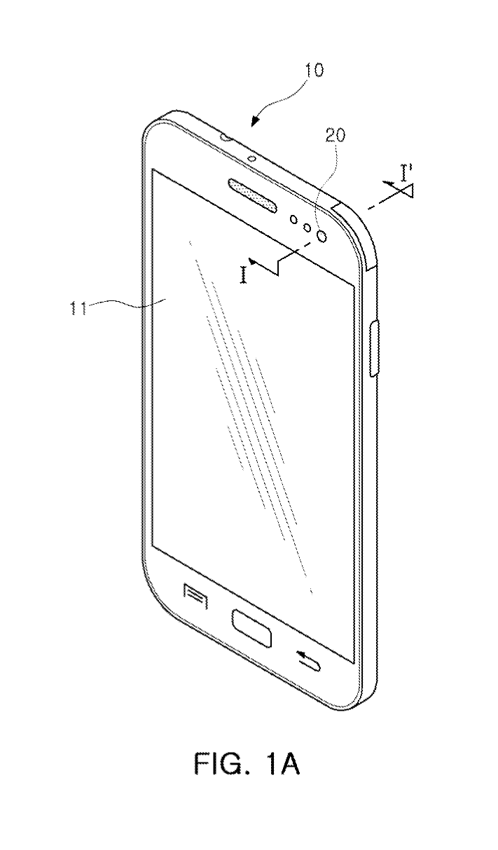

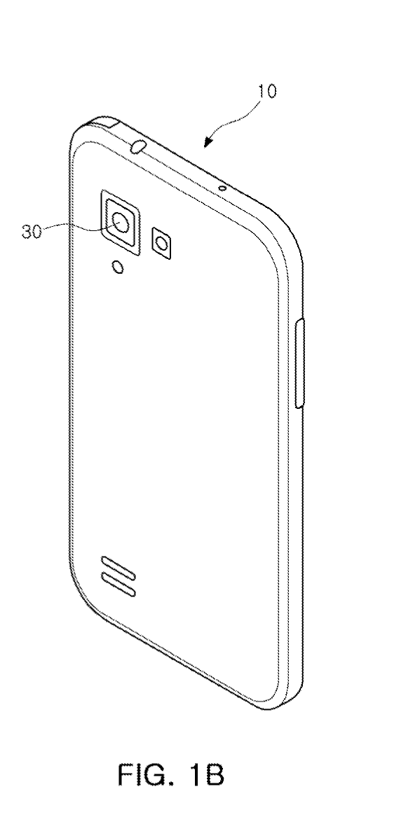

FIG. 1A is a front perspective view illustrating a portable electronic device, according to an embodiment. FIG. 1B is a rear perspective view illustrating the portable electronic device, according to an embodiment.

Referring to FIGS. 1A and 1B, a portable electronic device 10, according to an embodiment, is a portable electronic device such as a mobile communications terminal, a smartphone, a tablet personal computer (PC), or the like, in which a camera module is mounted.

As illustrated in FIG. 1A, a touch screen 11 is disposed on one surface (for example, a front surface) of a case of the portable electronic device 10, and a first opening 20 is formed in an upper end portion of one surface of the case so that light reflected from a subject is incident therein. As illustrated in FIG. 1A, the first opening 20 is formed on the upper end portion of the front surface of the case. However, in another embodiment, the first opening 20 may be formed on the upper end portion of a rear surface of the portable electronic device 10. The upper end portion may be at a left upper end portion, a center upper end portion, or a right upper end portion of the case, the front or the rear surface.

An illumination sensor, a proximity sensor, or other types of sensors, such as a focus sensor, may be disposed in the vicinity of the first opening 20.

In addition, as illustrated in FIG. 1B, a second opening 30 is formed in an upper end portion of another surface (for example, the rear surface) of the case of the portable electronic device 10, so that light reflected from a subject is incident. As illustrated in FIG. 1B, the second opening 30 is formed on the upper end portion of the rear surface of the case. However, in another embodiment, the second opening 30 may be formed on the upper end portion of a rear surface of the portable electronic device 10. The upper end portion may be at a left upper end portion, a center upper end portion, or a right upper end portion of the case, the front or the rear surface. A position of the first opening 20 would be opposite to a position of the second opening 30.

A flash, or the like, may be disposed in the vicinity of the second opening 30.

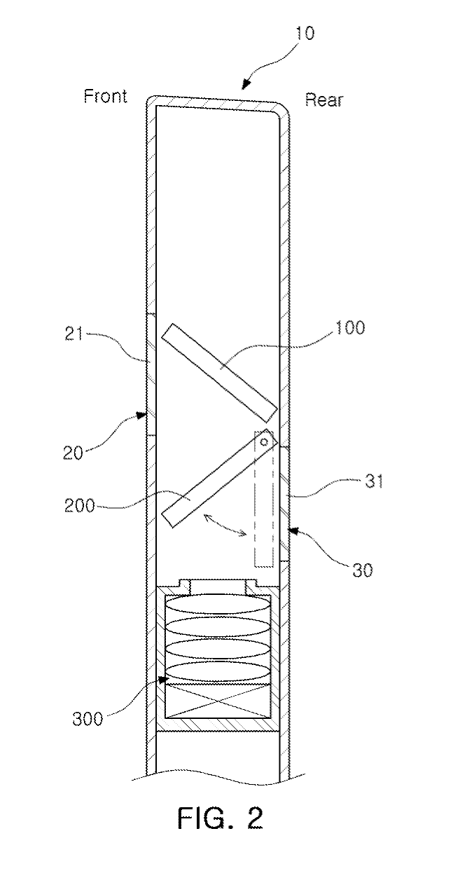

A camera module 300 (FIG. 2) is accommodated in the case of the portable electronic device 10, according to the embodiment. Therefore, both a subject disposed in front of the portable electronic device 10 and a subject disposed behind the portable electronic device 10 may be photographed using one camera module 300.

The camera module 300 includes at least one lens, an auto-focus actuator for auto-focusing, an optical image stabilizer actuator compensating for shake such as handshake, or the like, and an image sensor.

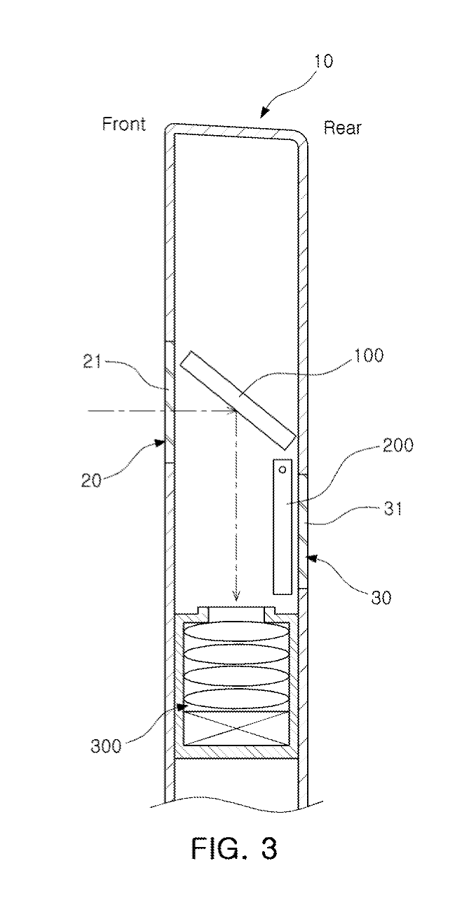

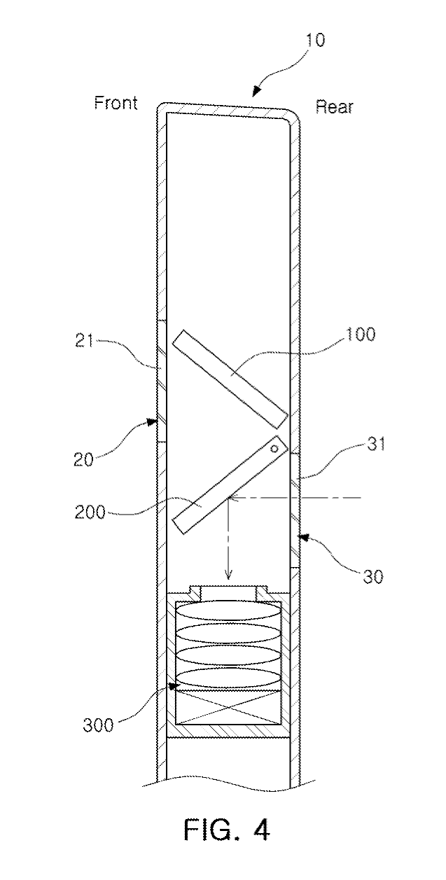

FIG. 2 is a schematic cross-sectional view taken along line I-I′ of FIG. 1A. FIG. 3 is a view illustrating an operational state of a camera module, according to an embodiment when photographing the subject in front of the portable electronic device 10. FIG. 4 is a view illustrating an operational state of the camera module, according to the embodiment, when photographing another subject in the rear of the portable electronic device 10.

First, referring to FIG. 2, a first transparent cover 21 is mounted on the first opening 20 of the portable electronic device 10, and a second transparent cover 31 is mounted on the second opening 30 of the portable electronic device 10.

In addition, the second opening 30 is formed opposite to the first opening, vertically or longitudinally offset to the first opening 20, or at a lower level than that of the first opening 20 or (for example, a level closer to the camera module 300). However, positions of the first opening 20 and the second opening 30 are not limited thereto, but may also be exchanged with each other.

The portable electronic device 10 includes the camera module 300 to photograph a subject disposed in front of the portable electronic device 10 and a subject disposed behind the portable electronic device 10.

In one example, the camera module 300 includes a plurality of reflecting parts reflecting light incident thereto from different directions to the lens of the camera module 300.

The reflecting parts are disposed in front of a first lens of lenses included in the camera module 300, along an optical axis direction.

The reflecting parts include a first reflecting part 100 reflecting light incident thereto from one side to the lens of the camera module 300 and a second reflecting part 200 reflecting light incident thereto from another side to the lens of the camera module 300.

The first reflecting part 100 is disposed horizontally aligned to the first opening 20 or at a position corresponding to that of the first opening 20. The first reflecting part 100 reflects light incident thereto through the first opening 20 toward the lenses of the camera module 300.

In addition, the second reflecting part 200 is disposed horizontally aligned to the second opening 30 or disposed at a position corresponding to that of the second opening 30, and reflects light incident thereto through the second opening 30 toward the lenses of the camera module 300.

For example, the first reflecting part 100 and the second reflecting part 200 are mirrors or prisms that reflect light.

Therefore, the camera module 300, according to an embodiment, photographs both a subject disposed in front of the portable electronic device 10 and another subject disposed behind the portable electronic device 10.

In an example, at least one of the first reflecting part 100 and the second reflecting part 200 are rotatably or pivotably installed.

A case in which only the second reflecting part 200 is rotatable is illustrated in the embodiment, but the present application is not limited thereto. That is, only the first reflecting part 100 rotate or pivot from a middle point thereof or from an end point thereof, or both the first reflecting part 100 and the second reflecting part 200 respectively rotate or pivot from a middle point thereof or from an end point thereof.

An operational state of the camera module 300 when photographing the subject in front of the portable electronic device 10 will be described with reference to FIG. 3.

As illustrated in FIG. 3, the first reflecting part 100 is fixedly installed in the portable electronic device 10 at a preset inclined angle (for example, 45°, with respect to an optical axis).

Here, the second reflecting part 200 is rotatably or pivotably installed in the portable electronic device 10. Therefore, the second reflecting part 200 may rotate or pivot so as not to interfere with a moving direction of light reflected from the first reflecting part 100.

The second reflecting part 200 has one end rotatably or pivotably installed in the portable electronic device 10, and rotates or pivots using the one end as a rotation center point or a pivotal center point.

In a case of photographing the subject in front of the portable electronic device 10, the second reflecting part 200 rotates toward the second opening 30 by a separate actuator (not illustrated) and aligns with or is parallel positioned to the second opening 30.

Therefore, the light reflected by the first reflecting part 100 is incident on the camera module 300 without interference by the second reflecting part 200.

In addition, the second reflecting part 200 closes the second opening 30, to thus prevent unnecessary light to be incident to an inner portion of the portable electronic device 10 through the second opening 30.

An operational state of the camera module 300 when photographing the rear of the portable electronic device 10 will be described with reference to FIG. 4.

As illustrated in FIG. 4, in a case of photographing the subject from the rear of the portable electronic device 10, the second reflecting part 200 rotates by the separate actuator (not illustrated) to have a preset inclined angle, of for example, 45°, with respect to the optical axis.

Therefore, light incident through the second opening 30 is reflected by the second reflecting part 200 and then be incident to the camera module 300.

In this example, the second reflecting part 200 is positioned in a moving path of the light reflected by the first reflecting part 100, and blocks any light reflected by the first reflecting part 100. Therefore, the light reflected by the first reflecting part 100 is prevented from being incident on the lens of the camera module 300.

As an example, when photographing the subject from the rear of the portable electronic device 10, one surface of the second reflecting part 200 is configured to reflect the light incident thereto through the second opening 30 toward the lens of the camera module 300. Another surface of the second reflecting part 200 is configured to block the light reflected by the first reflecting part 100.

Further, the first reflecting part 100 may be fixedly installed in the portable electronic device 10, and a reflection angle of the light by the first reflecting part 100 may, thus, be constant. However, the second reflecting part 200 may be rotatably installed in the portable electronic device 10, and a reflection angle of the light by the second reflecting part 200 may, thus, vary as the second reflecting part 200 rotates.

Therefore, in the embodiment, a stopper may be provided so that the second reflecting part 200 is accurately seated at and fixed in a position at which it has a preset inclined angle (for example, 45°, with respect to the optical axis) when photographing the rear.

In the camera module 300 configured as described above, the subject disposed in front of the portable electronic device 10 and the subject disposed behind the portable electronic device 10 may be photographed by the same camera module 300.

Therefore, a camera to photograph the subject in front and a camera for photographing the rear do not need to be separately configured in the portable electronic device 10, and thus the portable electronic device 10 may be further miniaturized.

Further, the camera module 300, according to an embodiment, is configured so that front photographing and rear photographing may be continuously performed.

As an example, when the camera module 300 photographs the subject in front, the second reflecting part 200 is maintained in a state in which it rotates to close or be positioned parallel to the second opening 30, such that the camera module 300 photographs the subject in front of the portable electronic device 10 by the light reflected by the first reflecting part 100. After the camera module 300 photographs the subject in front of the portable electronic device 10, the second reflecting part 200 rotates or pivots from one end thereof to open the second opening 30, such that the camera module 300 continuously performs the rear photographing after the front photographing.

Therefore, the camera module 300, according to an embodiment, continuously photographs an image at the front and an image at the rear of the portable electronic device 10. In addition, the camera module 300 may synthesize the image of the front with the image of the rear to generate one image. For example, if the image of the front is a selfie image and the image of the rear is a background image, an image of a photographer himself (herself) may be cropped from the selfie image, and then be synthesized with the background image. Therefore, the same effect as photographing the photographer himself (herself) and a background at the same time may be obtained.

The image sensor of the camera module 300, according to an embodiment, is a dual pixel image sensor in which two photodiodes are integrated in one pixel.

Therefore, in the image sensor of the camera module 300, according to an embodiment, the two photodiodes integrated in the one pixel may recognize light, respectively, to detect a phase difference. Therefore, depth information on the subject may be obtained from the photographed image.

As a result, a desired portion, for example, the photographer himself (herself) when the photographed image is the selfie image, may be cropped from the photographed image, and then be synthesized with another image.

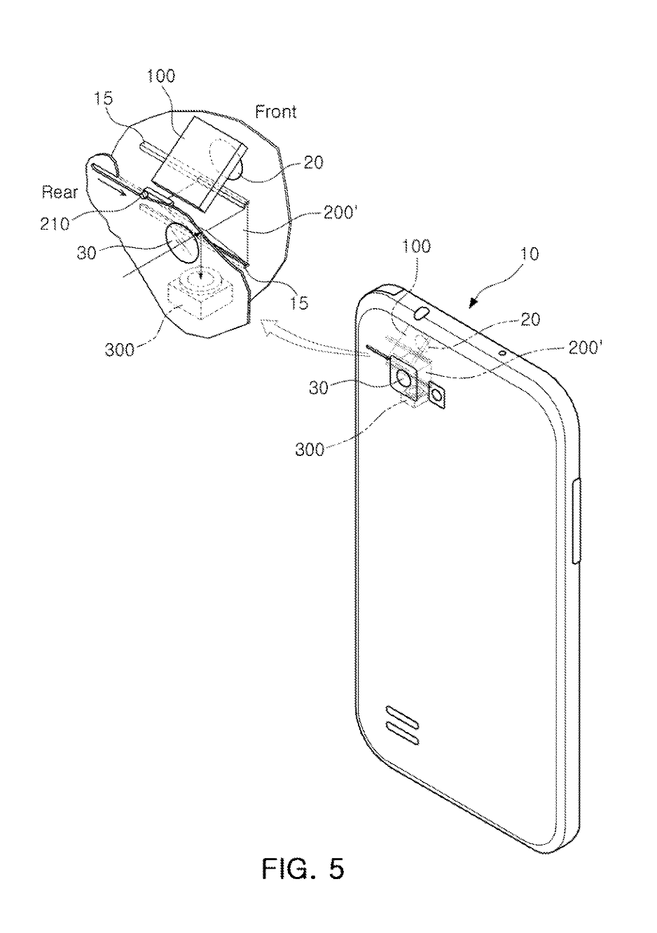

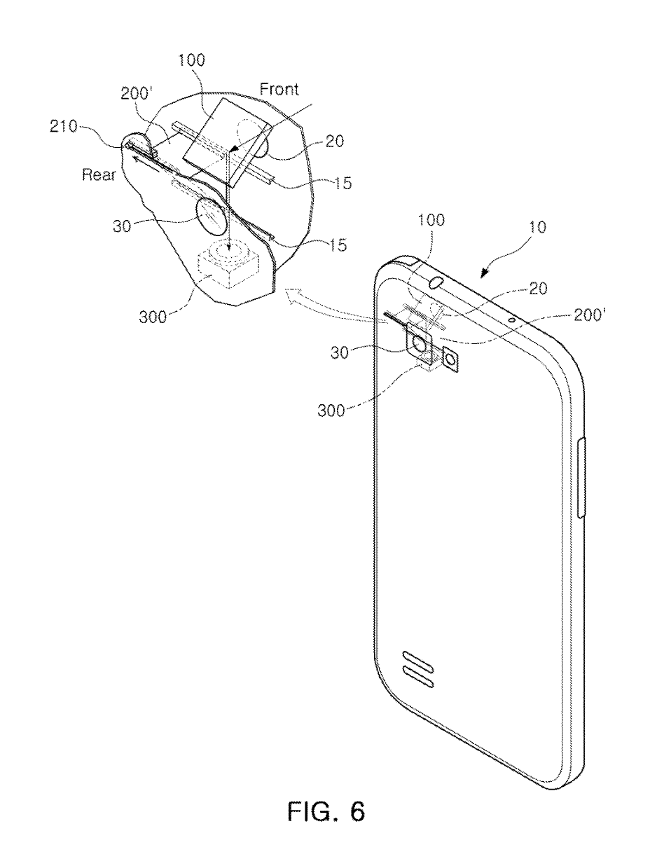

FIG. 5 is a view illustrating an operational state of a camera module, according to an embodiment, when photographing a subject in front of the portable electronic device 10. FIG. 6 is a view illustrating an operational state of the camera module, according to another embodiment in the present disclosure when photographing a subject at a rear of the portable electronic device 10.

Referring to FIGS. 5 and 6, the camera module 300, according to an embodiment, is the same as the camera module 300 described above, except for an actuating manner of a second reflecting part 200′. Thus, a description of parts other than a description of the actuating manner of the second reflecting part 200′ will be omitted.

In an embodiment, the second reflecting part 200′ may be slidably installed in the portable electronic device 10.

As an example, the portable electronic device 10 includes a guide groove 15, and the second reflecting part 200′ includes a guide protrusion (not shown) or a portion of the second reflecting part 200′ configured to be slidably inserted into the guide groove 15. However, positions of the guide groove 15 and the guide protrusion are not limited thereto, but may also be exchanged with each other.

Referring to FIG. 5, in a case of photographing the subject in front of the portable electronic device 10, the second reflecting part 200′ moves in a direction parallel to an optical axis so as not to interfere with a moving direction of light reflected by the first reflecting part 100.

Therefore, light incident through the first opening 20 may be reflected by the first reflecting part 100 and then be incident to the lens of the camera module 300.

In an example, the second reflecting part 200′ may include a blocking film to block unnecessary light (for example, light incident thereto through the second opening 30) when photographing the subject in front of the portable electronic device 10. The blocking film may be installed to one side of the second reflecting part 200′ to close the second opening 30.

The second reflecting part 200′ slides in the direction parallel to the optical axis by a separate actuator (not illustrated).

In addition, the second reflecting part 200′ is provided with a grip part 210, protruding outwardly of the portable electronic device 10, so that the photographer may move the second reflecting part 200′ manually.

Therefore, the photographer may push or pull the grip part 210 manually, to selectively perform the front photographing and the rear photographing.

Next, referring to FIG. 6, in the case of photographing a subject from the rear of the portable electronic device 10, the second reflecting part 200′ moves in the direction perpendicular to the optical axis to reflect the light incident thereto through the second opening 30 toward the camera module 300.

Therefore, light incident through the second opening 30 is reflected by the second reflecting part 200′ and is then incident on the first lens of the camera module 300.

In this case, the second reflecting part 200′ may be positioned along a moving path of the light reflected by the first reflecting part 100, and blocks the light reflected by the first reflecting part 100. Therefore, the light reflected by the first reflecting part 100 is prevented from being incident on the first lens of the camera module 300.

As an example, when photographing the subject from the rear of the portable electronic device 10, one surface of the second reflecting part 200′ is configured to reflect the light incident thereto through the second opening 30 toward the lens of the camera module 300, and the other surface of the second reflecting part 200′ is configured to block the light reflected by the first reflecting part 100.

In accordance with an embodiment, the second reflecting part 200 is rotatably or pivotably installed in the camera module, and the second reflecting part 200′ is slidably installed in the camera module. In an embodiment, a second reflecting part may also be fixedly installed in the portable electronic device.

In this case, the second reflecting part may be a liquid crystal display (LCD) panel fixedly installed to have a preset inclined angle, for example, 45°, with respect to the optical axis.

Therefore, the second reflecting part 200 or 200′ may pass light therethrough or reflect the light, depending on whether or not a voltage is applied to the second reflecting part 200 or 200′.

As an example, when the voltage is not applied to the second reflecting part, the light reflected by the first reflecting part 100 passes through the second reflecting part and is then incident on the first lens of the camera module 300.

Therefore, when photographing the subject in front of the portable electronic device 10, the voltage is not applied to the second reflecting part. As a result, the light reflected by the first reflecting part 100 passes through the second reflecting part and is then incident on the first lens of the camera module 300. In this case, a shutter member using the grip part 210 to close the second opening 30 may be included so that unnecessary light is not incident through the second opening 30.

In addition, when the voltage is applied to the second reflecting part 200 or 200′, the second reflecting part 200 or 200′ does not pass the light therethrough, but reflects the light. Therefore, the light incident through the second opening 30 is reflected by the second reflecting part 200 or 200′ and is then incident on the first lens of the camera module 300.

When photographing the subject from the rear of the portable electronic device 10, the voltage is applied to the second reflecting part 200 or 200′, to allow the light reflected by the second reflecting part 200 or 200′ to be incident on the first lens of the camera module 300. In this example, the shutter member is open to allow the light to be incident through the second opening 30.

Meanwhile, a shutter member closing the first opening 20 so that unnecessary light is not incident through the first opening 20 may be additionally provided.

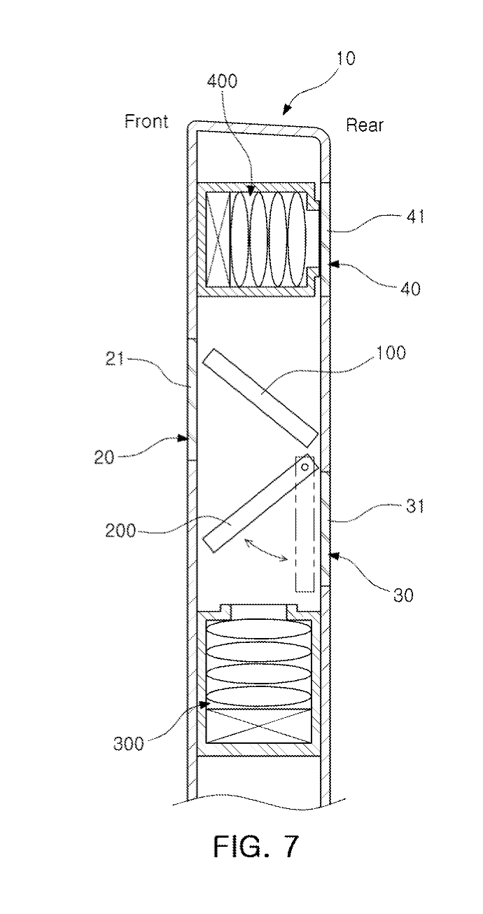

FIG. 7 is a schematic cross-sectional view illustrating a portable electronic device in which a camera module, according to an embodiment, is mounted.

Referring to FIG. 7, the camera module, according to an embodiment, includes at least two camera modules.

A first camera module 300 may be a camera module configured so that both front photographing and rear photographing are possible, as with the camera modules 300, according to the first and second exemplary embodiments described above, and a second camera module 400 may be a camera module configured so that front photographing or rear photographing is possible.

The second module 400 is configured so that the rear photographing is possible. To this end, a third opening 40 is formed in an upper end portion of a rear surface of the portable electronic device 10 so that light reflected from a subject is incident, and a third transparent cover 41 is mounted in the third opening 40.

The first camera module 300 and the second camera module 400 have different viewing angles.

As an example, either the first camera module 300 or the second camera module 400 has a relatively wider viewing angle (a wide angle lens), and the other of the first camera module 300 or the second camera module 400 has a relatively narrower viewing angle (a telephoto lens).

The two camera modules 300 and 400 are configured to have the different viewing angles as described above, and, thus, photograph images of a subject at various depths.

In addition, because an image having a high level of resolution or a bright image may be generated by using two images for one subject (for example, by synthesizing), the image of the subject is clearly photographed, even in an environment in which illumination is low.

In addition, a three-dimensional (3D) image may be implemented using a plurality of images, and a zoom function may also be implemented.

Further, an optical axis of a lens of the first camera module 300 and an optical axis of a lens of the second camera module 400 are perpendicular to each other.

As an example, the optical axis of the lens of the second camera module 400 are formed in a direction in which light is incident to the portable electronic device 10, that is, a thickness direction of the portable electronic device 10. The optical axis of the lens of the first camera module 300 is formed in a direction, such as a length direction of the portable electronic device 10, perpendicular to the direction in which the light is incident to the portable electronic device 10.

Because the optical axis of the lens of the first camera module 300 is formed in the length direction of the portable electronic device 10, a size of the first camera module 300 is not restricted by a thickness of the portable electronic device 10.

Therefore, even though additional components for an auto-focus function, a handshake compensating function, a zoom function, and the like, are provided in the camera module 300, the thickness of the portable electronic device 10 is not increased.

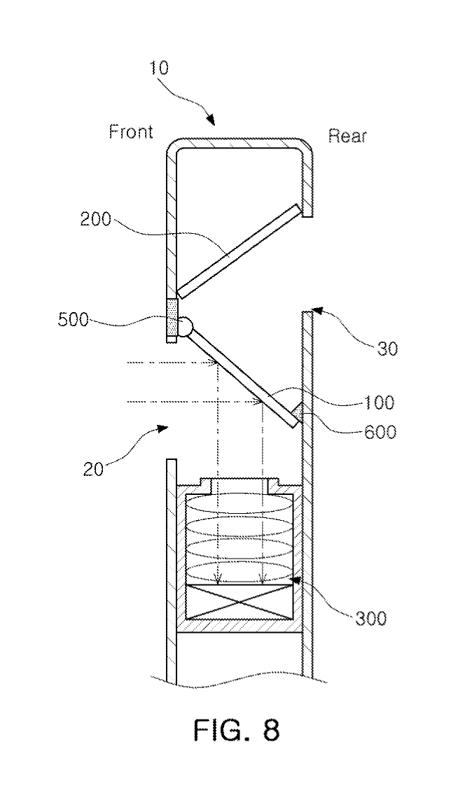

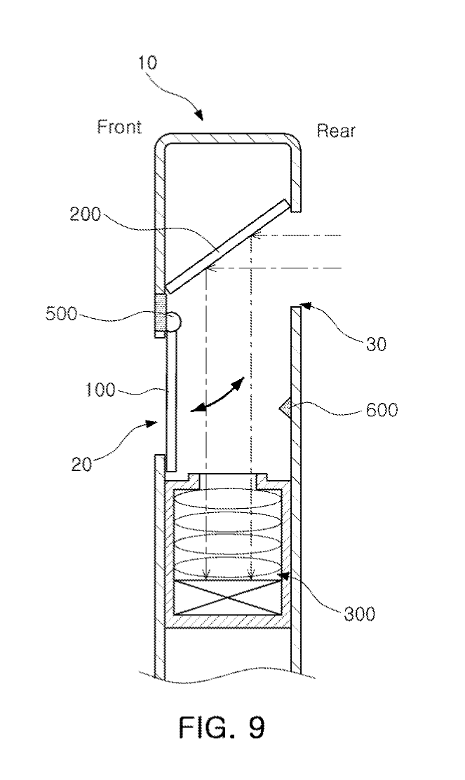

FIG. 8 is a view illustrating an operational state of a camera module, according to an embodiment when photographing the subject that is at the front of the portable electronic device 10. FIG. 9 is a view illustrating an operational state of the camera module, according to an embodiment, when photographing the subject that is at the rear of the portable electronic device 10.

First, referring to FIG. 8, the portable electronic device 10 has openings formed on one surface and another surface thereof, respectively, so that light incident from subjects is incident.

As an example, a first opening 20 is formed in a front surface of the portable electronic device 10 so that light reflected from a subject positioned in front of the portable electronic device 10 is incident, and a second opening 30 is formed in a rear surface of the portable electronic device 10 so that light reflected from a subject positioned at a rear or behind of the portable electronic device 10 is incident. Although not illustrated, a first transparent cover may be mounted in the first opening 20, and a second transparent cover is mounted in the second opening 30.

The portable electronic device 10 includes a camera module 300 to photograph a subject disposed in front of the portable electronic device 10 and a subject disposed behind the portable electronic device 10.

In an embodiment, the camera module 300 includes a first reflecting part 100 and a second reflecting part 200.

As illustrated in FIG. 8, a housing including at least one lens, an image sensor, the first reflecting part 100, and the second reflecting part 200 are provided inside a case of the portable electronic device 10.

Alternatively, a separate housing may be provided in the case of the portable electronic device 10, and at least one lens, an image sensor, the first reflecting part 100, and the second reflecting part 200 are disposed in the housing.

The first reflecting part 100 is disposed at a position corresponding to that of the first opening 20, and reflects light incident thereto through the first opening 20 toward the lens of the camera module 300.

In addition, the second reflecting part 200 is disposed at a position corresponding to that of the second opening 30, and reflects light incident thereto through the second opening 30, toward the lens of the camera module 300.

For example, the first reflecting part 100 and the second reflecting part 200 are mirrors or prisms that reflect light.

Therefore, the camera module 300, according to an embodiment, photographs both, the subject disposed in front of the portable electronic device 10 and the subject disposed behind the portable electronic device 10.

The first reflecting part 100 is disposed on a level closer to the lens of the camera module 300, compared to the second reflecting part 200.

In an example, at least one of the first reflecting part 100 and the second reflecting part 200 are rotatably or pivotably installed.

An actuator 500 is provided in order to rotate at least one of the first reflecting part 100 and the second reflecting part 200.

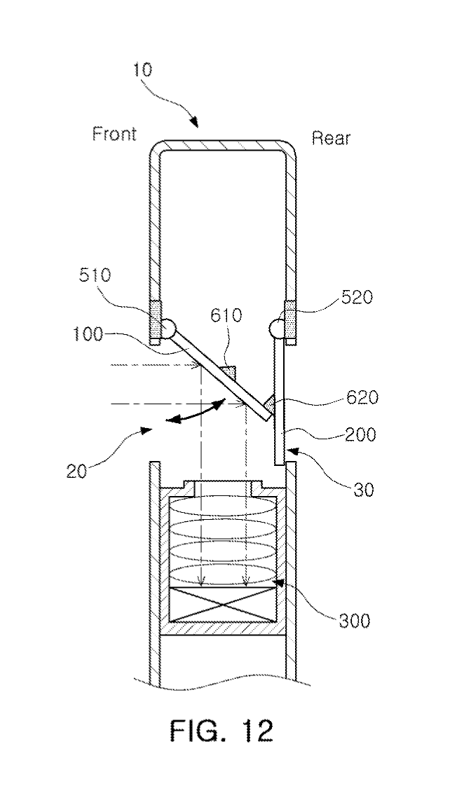

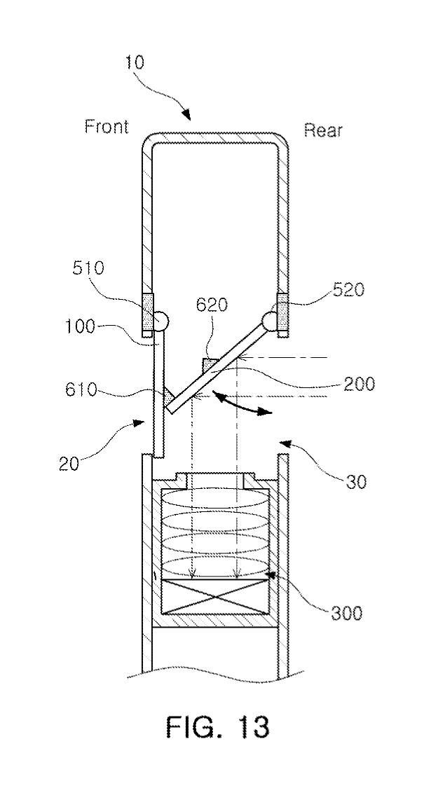

In one example, only the first reflecting part 100 is rotatable is illustrated in the present exemplary embodiment, but the present description is not limited thereto. That is, both the first reflecting part 100 and the second reflecting part 200 may be rotatably or pivotably installed as in an embodiment illustrated in FIGS. 12 and 13.

Next, an operational state of the camera module 300 when photographing the front of the portable electronic device 10 will be described.

In this example, the first reflecting part 100 is rotatably installed in the portable electronic device 10.

As an example, the first reflecting part 100 has one end rotatably installed in the portable electronic device 10, and rotates, using the one end as a rotation center point. To this end, the actuator 500 rotating the first reflecting part 100 may be provided in the portable electronic device 10.

As illustrated in FIG. 8, in a case of photographing the front of the portable electronic device 10, the actuator 500 rotates the first reflecting part 100 to have a preset inclined angle of, for example, 45°, with respect to the optical axis.

Therefore, light incident through the first opening 20 is reflected by the first reflecting part 100 and is then incident on the lens of the camera module 300.

Meanwhile, as illustrated in FIG. 8, the second reflecting part 200 is fixedly installed in the portable electronic device 10 to have a preset inclined angle, of for example, 45°, with respect to the optical axis, and light incident through the second opening 30 is reflected by the second reflecting part 200.

In a case of photographing the front of the portable electronic device 10, it may be necessary to prevent the light reflected by the second reflecting part 200 from being incident on the lens of the camera module 300.

The first reflecting part 100 is positioned in a moving path of the light reflected by the second reflecting part 200, and blocks the light reflected by the second reflecting part 200. Therefore, in the case of photographing the subject in front of the portable electronic device 10, the light reflected by the second reflecting part 200 is prevented from being incident on the lens of the camera module 300.

As an example, when photographing the subject in front of the portable electronic device 10, one surface of the first reflecting part 100 is configured to reflect the light incident thereto through the first opening 20 toward the lens of the camera module 300, and another surface of the first reflecting part 100 is configured to block the light reflected by the second reflecting part 200.

Further, the second reflecting part 200 is fixedly installed in the portable electronic device 10, and a reflection angle of the light by the second reflecting part 200 is constant. However, the first reflecting part 100 is rotatably installed in the portable electronic device 10, and a reflection angle of the light by the first reflecting part 100 is not constant whenever the first reflecting part 100 rotates, in a case in which the first reflecting part 100 is not disposed in an appropriate position when the first reflecting part 100 rotates.

Therefore, in an embodiment, a stopper 600 is provided so that the first reflecting part 100 is accurately seated at and fixed in a position at which it has a preset inclined angle (for example, 45°, with respect to the optical axis) when photographing the front. That is, the stopper 600 limits a rotation range of the first reflecting part 100.

The stopper 600 is provided on an inner surface of the portable electronic device 10. As an example, the stopper 600 is disposed at a position corresponding to the position at which the first reflecting part 100 has the preset inclined angle of, for example, 45°, with respect to the optical axis.

Therefore, the first reflecting part 100 is closely adhered to the stopper 600 and rotates to the position at which the first reflecting part 100 has the preset inclined angle of, for example, 45°, with respect to the optical axis. As a resultant, a reflection angle of the light by the first reflecting part 100 is constant whenever the first reflecting part 100 rotates.

Further, because the first reflecting part 100 is rotatably or pivotably installed, a space is provided between the first reflecting part 100 and the inner surface of the portable electronic device 10, so that the first reflecting part 100 may rotate.

However, when the space is formed between the first reflecting part 100 and the inner surface of the portable electronic device 10, even in a state in which the rotation of the first reflecting part 100 is completed, some of the light incident through the first opening 20 may be incident on the space between the first reflecting part 100 and the inner surface of the portable electronic device 10, thus, unintentionally being reflected, which may cause a flare phenomenon in a photographed image.

Therefore, in an embodiment, the first reflecting part 100 is closely adhered to the inner surface of the portable electronic device 10 and rotates to the position at which the first reflecting part 100 has the preset inclined angle of, for example, 45°, with respect to the optical axis, in order to prevent the flare phenomenon from occurring due to the unintentional reflection of the light.

That is, when photographing the front of the portable electronic device, the space for rotation is provided between the first reflecting part 100 and the inner surface of the portable electronic device 10 in the state in which the first reflecting part 100 rotates, but the space may not be formed between the first reflecting part 100 and the inner surface of the portable electronic device 10. Also, the first reflecting part 100 and the portable electronic device 10 may be closely adhered to each other, in the state in which the rotation of the first reflecting part 100 is completed.

Although not illustrated in the drawings, a blocking member is provided at the position at which the first reflecting part 100 rotates, to have the preset inclined angle of, for example, 45°, with respect to the optical axis, in order to prevent the space from being formed between the first reflecting part 100 and the inner surface of the portable electronic device 10 when photographing the front of the portable electronic device 10.

That is, although not illustrated in FIGS. 8 and 9, the blocking member may be provided at a side surface portion, for example, a portion corresponding to the position at which the first reflecting part 100 rotates to have the preset inclined angle of, for example, 45°, with respect to the optical axis, of the inner surface of the portable electronic device 10.

Meanwhile, because the stopper 600 illustrated in FIGS. 8 and 9 is disposed at a position corresponding to the position at which the first reflecting part 100 has the preset inclined angle of, for example, 45°, with respect to the optical axis, the stopper 600 may also serve to fix the position of the first reflecting part 100 and may serve as the blocking member.

An operational state of the camera module 300 when photographing the rear of the portable electronic device 10 will be described with reference to FIG. 9.

As illustrated in FIG. 9, the second reflecting part 200 is fixedly installed in the portable electronic device 10 to have a preset inclined angle of, for example, 45°, with respect to the optical axis, and light incident through the second opening 30 is reflected by the second reflecting part 200 and is then incident on the first lens of the camera module 300.

In a case of photographing the subject at the rear of the portable electronic device 10, the first reflecting part 100 rotates so as to not interfere with a moving direction of the light reflected by the second reflecting part 200.

As an example, when photographing the subject at the rear of the portable electronic device 10, the actuator 500 rotates the first reflecting part 100 to close the first opening 20.

In addition, when photographing the subject at the rear of the portable electronic device 10, the first reflecting part 100 closes the first opening 20, to prevent unnecessary light from being incident from the front through the first opening 20.

Also, when photographing the subject at the rear of the portable electronic device 10, in a case in which a space is formed between the second reflecting part 200 and the inner surface of the portable electronic device 10, some of the light incident through the second opening 30 may be incident at the space between the second reflecting part 200 and the inner surface of the portable electronic device 10, thus, being unintentionally reflected, which may cause a flare phenomenon in a photographed image.

Therefore, in an embodiment, the second reflecting part 200 is closely adhered and fixed to the inner surface of the portable electronic device 10, in order to prevent the flare phenomenon from occurring, due to the unintentional reflection of the light.

That is, when photographing the subject at the rear of the portable electronic device 10, the space may not be formed between the second reflecting part 200 and the inner surface of the portable electronic device 10, and the second reflecting part 200 and the portable electronic device 10 may be closely adhered to each other.

Although not illustrated in the drawings, when photographing the subject at the rear of the portable electronic device 10, a blocking member may be provided between the second reflecting part 200 and the inner surface of the portable electronic device 10 in order to prevent the space from being formed between the second reflecting part 200 and the inner surface of the portable electronic device 10.

That is, although not illustrated in FIGS. 8 and 9, the blocking member may be provided at a side surface portion, for example, a portion corresponding to a position at which the second reflecting part 200 is fixedly installed, of the inner surface of the portable electronic device 10.

In the camera module 300 configured as described above, the subject disposed in front of the portable electronic device 10 and the subject disposed behind the portable electronic device 10 may be photographed by the same camera module 300.

Therefore, a camera to photograph the front and a camera to photograph the rear do not need to be separately configured in the portable electronic device 10, and thus the portable electronic device 10 may be further miniaturized.

Meanwhile, the camera module 300, according to an embodiment, may be configured so that front photographing and rear photographing are continuously performed, as with the camera module 300 according to the first exemplary embodiment, described above.

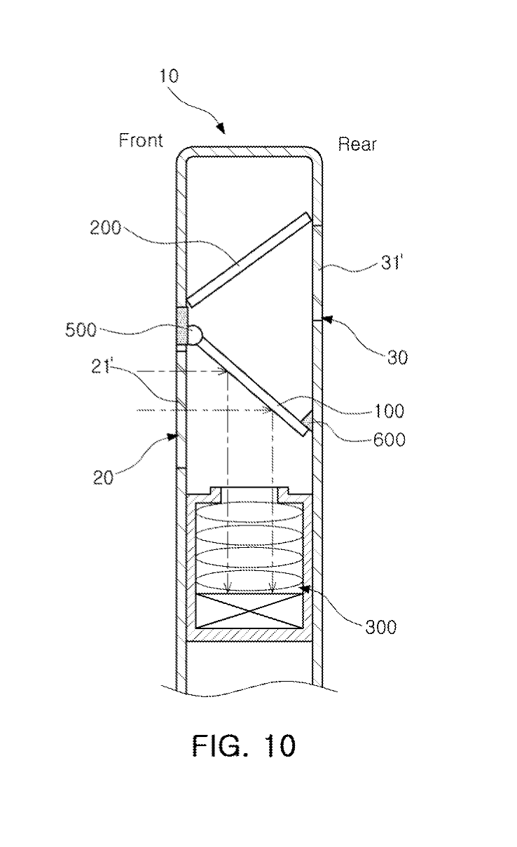

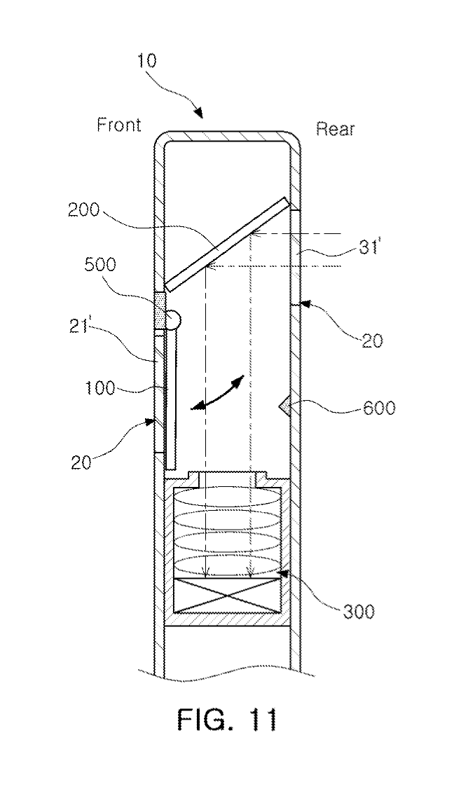

FIG. 10 is a view illustrating an operational state of a camera module, according to an embodiment, when photographing the subject in front of the portable electronic device 10. FIG. 11 is a view illustrating an operational state of the camera module, according to an embodiment, when photographing the subject from the rear of the portable electronic device 10.

Some of the features of the camera module described in FIG. 10 and FIG. 11, according to an embodiment, are the same as the camera module as described above, except for a first filter 21′ and a second filter 31′, and a description other than a description for the first filter 21′ and the second filter 31′ will thus be omitted.

A first filter 21′ is mounted in the first opening 20 of the portable electronic device 10, and a second filter 31′ is mounted in the second opening 30 of the portable electronic device 10.

The first filter 21′ is a visible ray cut-off filter or an infrared ray pass filter. Therefore, the first filter 21′ filters a visible ray in the light incident thereto through the first opening 20.

Because the visible ray in the light incident through the first opening 20 is filtered by the first filter 21′, an infrared ray image may be photographed.

In one example, the infrared ray image is an image for an iris of a user. In this case, the camera module 300 serves as an iris recognizing camera.

The second filter 31′ is an infrared ray cut-off filter. Therefore, the second filter 31′ filters an infrared ray in the light incident thereto through the second opening 30.

Because the infrared ray in the light incident through the second opening 30 is filtered by the second filter 31′, a visible ray image may be photographed.

In the camera module 300 configured as described above, the iris of the user is recognized and an image of a visible ray region is photographed by the same camera module 300.

Therefore, a camera to recognize the iris and a camera for general photographing do not need to be separately configured in the portable electronic device 10, and thus the portable electronic device 10 may be further miniaturized.

FIG. 12 is a view illustrating an operational state of a camera module, according to another embodiment, when photographing the subject in front of the portable electronic device 10. FIG. 13 is a view illustrating an operational state of the camera module, according to an embodiment, when photographing the subject at the rear of the portable electronic device 10.

In the camera module, a first opening 20 and a second opening 30 are formed at positions corresponding to each other in a width direction and a length direction of the portable electronic device 10 (or the optical axis direction of the camera module 300).

Each of the first reflecting part 100 and the second reflecting part 200 are rotatably or pivotably installed.

A first actuator 510 is provided in order to rotate the first reflecting part 100, and a second actuator 520 is provided in order to rotate the second reflecting part 200.

When photographing the front of the portable electronic device 10, the first actuator 510 rotates the first reflecting part 100 to have a preset inclined angle of, for example, 45°, with respect to the optical axis.

Therefore, light incident through the first opening 20 may be reflected by the first reflecting part 100 and then be incident on the lens of the camera module 300.

Further, when photographing the front of the portable electronic device 10, the second actuator 520 rotates the second reflecting part 200 to close the second opening 30.

Therefore, in a case of photographing the front of the portable electronic device 10, unnecessary light may be prevented from being incident through the second opening 30.

When photographing the subject at the rear of the portable electronic device 10, the actuator 520 rotates the second reflecting part 200 to have a preset inclined angle of, for example, 45°, with respect to the optical axis.

Therefore, light incident through the second opening 30 may be reflected by the second reflecting part 200 and then be incident to the lens of the camera module 300.

Further, when photographing the subject at the rear of the portable electronic device 10, the actuator 510 rotates the first reflecting part 100 to close the first opening 20.

Therefore, in a case of photographing the rear of the portable electronic device 10, unnecessary light may be prevented from being incident through the first opening 20.

One surface of the first reflecting part 100 and one surface of the second reflecting part 200 are configured to reflect the light, and the other surface of the first reflecting part 100 and the other surface of the second reflecting part 200 are configured to block the light.

Also, one surface of the first reflecting part 100 and one surface of the second reflecting part 200 are surfaces of the first reflecting part 100 and the second reflecting part 200 in directions in which light is incident, and the other surface of the first reflecting part 100 and the other surface of the second reflecting part 200 are surfaces of the first reflecting part 100 and the second reflecting part 200 facing each other, for example, surfaces of the first reflecting part 100 and the second reflecting part 200 facing toward an inner portion of the portable electronic device 10.

Also, in a example in which the first reflecting part 100 and the second reflecting part 200 are disposed in appropriate positions when the first reflecting part 100 and the second reflecting part 200 rotate, both the first reflecting part 100 and the second reflecting part 200 are rotatably installed, and reflection angles of the light by the first reflecting part 100 and the second reflecting part 200 may not be constant whenever the first reflecting part 100 and the second reflecting part 200 rotate.

Therefore, in an embodiment, stoppers are provided so that the first reflecting part 100 and the second reflecting part 200 are accurately seated at and fixed in positions at which they have a preset inclined angle of, for example, 45°, with respect to the optical axis.

As an example, the first reflecting part 100 is provided with a first stopper 610, and the second reflecting part 200 may be provided with a second stopper 620.

The respective stoppers 610 and 620 are provided on surfaces of the respective reflecting parts 100 and 200 facing each other (for example, the surfaces of the first reflecting part 100 and the second reflecting part 200 facing toward the inner portion of the portable electronic device 10).

When photographing the front of the portable electronic device 10, the first reflecting part 100 rotates to the position at which it has the preset inclined angle of, for example, 45°, with respect to the optical axis, to be closely adhered to the second stopper 620 provided on the second reflecting part 200 (see FIG. 12).

Therefore, the first reflecting part 100 enable a reflection angle of the light to be constant whenever the first reflecting part 100 rotates.

In addition, when photographing the rear of the portable electronic device 10, the second reflecting part 200 rotates to the position at which it has the preset inclined angle of, for example, 45°, with respect to the optical axis, to be closely adhered to the first stopper 610, which is provided on the first reflecting part 100 (see FIG. 13).

Therefore, the second reflecting part 200 enables a reflection angle of the light to be constant whenever it rotates.

Furthermore, in a state in which the rotation of the first reflecting part 100 or the second reflecting part 200 is completed, so that the first reflecting part 100 or the second reflecting part 200 has the preset inclined angle of, for example, 45°, with respect to the optical axis, the first reflecting part 100 or the second reflecting part 200 closely adheres to an inner surface of the portable electronic device 10.

Because configurations and operations of the first reflecting part 100 and the second reflecting part 200 are similar to each other, a description for the second reflecting part 200 will be omitted, and the first reflecting part 100 will be described primarily, in order to avoid redundancy.

Because the first reflecting part 100 is rotatably installed, a space is provided between the first reflecting part 100 and the inner surface of the portable electronic device 10, so that the first reflecting part 100 rotates.

However, when the space is formed between the first reflecting part 100 and the inner surface of the portable electronic device 10, even in the state in which the rotation of the first reflecting part 100 is completed, so that the first reflecting part 100 has the preset inclined angle of, for example, 45°, with respect to the optical axis, unintended reflection of the light may be generated in the space, which may cause a flare phenomenon.

Therefore, in an embodiment, the first reflecting part 100 closely adheres to the inner surface of the portable electronic device 10 in the state in which the first reflecting part 100 rotates to the position at which the first reflecting part 100 has the preset inclined angle of, for example, 45°, with respect to the optical axis, in order to prevent the flare phenomenon.

That is, when photographing the front of the portable electronic device, the space for rotation is provided between the first reflecting part 100 and the inner surface of the portable electronic device 10 in the state in which the first reflecting part 100 rotates, but the space may not be formed between the first reflecting part 100 and the inner surface of the portable electronic device 10. Also, the first reflecting part 100 and the portable electronic device 10 may be closely adhered to each other, in the state in which the rotation of the first reflecting part 100 is completed.

Although not illustrated in the drawings, when photographing the front of the portable electronic device 10, a blocking member may be provided at the position at which the first reflecting part 100 rotates to have the preset inclined angle of, for example, 45°, with respect to the optical axis, in order to prevent the space from being formed between the first reflecting part 100 and the inner surface of the portable electronic device 10.

That is, although not illustrated in FIGS. 12 and 13, the blocking member may be provided at a side surface portion (for example, a portion corresponding to the position at which the first reflecting part 100 rotates to have the preset inclined angle (for example, 45°, with respect to the optical axis)) of the inner surface of the portable electronic device 10.

As set forth above, in the camera module and the portable electronic device including the same, according to embodiments, the subjects positioned at opposite sides of the portable electronic device may be photographed using one camera module, and a demand for miniaturization may be satisfied.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
lenses; and
reflecting parts disposed in front of the lenses and configured to reflect light incident thereto from different directions to the lenses,
wherein a reflecting part of the reflecting parts is rotatable, and
a stopper configured to limit a rotation range of the reflecting part.

2. The camera module of claim 1, wherein the reflecting part and the stopper are closely positioned with respect to each other so that the reflecting part rotates to have a preset inclined angle.

3. The camera module of claim 1, wherein the reflecting parts are mirrors or prisms.

4. The camera module of claim 1, wherein the reflecting parts comprise:
a first reflecting part configured to reflect light incident thereto from one side to the lenses, and
a second reflecting part configured to reflect light incident thereto from another side to the lenses.

5. The camera module of claim 4, wherein the first reflecting part is configured to be rotatable, and the second reflecting part is fixed at an inclined angle.

6. The camera module of claim 5, wherein the first reflecting part is disposed on a level closer to the lenses compared to the second reflecting part, and
one surface of the first reflecting part reflects the light, and another surface of the first reflecting part blocks the light.

7. The camera module of claim 4, further comprising:
a first filter disposed in front of the first reflecting part; and
a second filter disposed in front of the second reflecting part,
wherein each of the first filter and the second filter is an infrared ray pass filter or an infrared ray cut-off filter.

8. The camera module of claim 1, further comprising:
an actuator rotating the reflecting part.

9. A camera module comprising:
lenses;
reflecting parts disposed in front of the lenses and configured to reflect light incident thereto from different directions to the lenses;
actuators configured to rotate the reflecting parts; and
stoppers configured to limit rotation ranges of the reflecting parts.

10. The camera module of claim 9, wherein one surface of each of the reflecting parts reflects the light, and another surface of each of the reflecting parts blocks the light.

11. The camera module of claim 9, wherein the stoppers are provided on surfaces of the reflecting parts facing each other.

12. The camera module of claim 9, wherein the reflecting parts comprise:
a first reflecting part configured to reflect light incident thereto from one side to the lenses,
a second reflecting part configured to reflect light incident thereto from another side to the lenses, and
first and second stoppers are disposed on surfaces of the first and second reflecting parts facing each other.

13. The camera module of claim 12, wherein the first reflecting part is closely positioned to the second stopper and the first reflecting part rotates to an inclined angle, and
the second reflecting part is closely positioned to the first stopper and the second reflecting part rotates at an inclined angle.

14. A portable electronic device, comprising:
the camera module of claim 1; and
a case comprising openings formed in one surface and another surface thereof so that light is incident thereto and accommodating the camera module therein.

15. A portable device, comprising:
a first reflecting part disposed at a position aligned with a first opening on a front side of the portable device and rotatably installed with respect to an optical axis, and configured to reflect light incident thereto through the first opening toward a lens of a camera module; and
a second reflecting part disposed at a position aligned with a second opening on a rear side of the portable device and fixedly installed at a preset inclined angle with respect to the optical axis, wherein the second reflecting part reflects light incident through the second opening toward the lens of the camera module.

16. The portable device of claim 15, wherein, in response to photographing a subject in front of the portable device, the first reflecting part is closely adhered to the inner surface of the portable device and rotates to a position at which the first reflecting part has an inclined angle with respect to the optical axis.

17. The portable device of claim 15, wherein, in response to photographing a subject in front of the portable device, the first reflecting part is positioned in a moving path of the light reflected by the second reflecting part to block the light reflected by the second reflecting part.

18. The portable device of claim 15, wherein in response to photographing a subject in a rear of the portable device, the first reflecting part rotates to close the first opening to prevent interfering with a moving direction of the light reflected by the second reflecting part.

19. The portable device of claim 15, wherein the second reflecting part is closely adhered and fixed to an inner surface of the portable device.

20. The portable device of claim 15, further comprising:
a stopper fixed in a position within the portable device to limit a rotation range of the first reflecting part to an inclined angle of 45°.
